(19) United States
(12) Patent Application Publication
(10) Pub. No.: US 2011/0010269 A1
(43) Pub. Date: Jan. 13, 2011

(54) VEHICLE AUDIO SYSTEM FOR PRODUCING SYNTHETIC ENGINE SOUND

(76) Inventor: CLAUDIO R. BALLARD, FORT LAUDERDALE, FL (US)

Correspondence Address: HOWISON & ARNOTT, L.L.P, P.O. BOX 741715, DALLAS, TX, 75374-1715, US

(21) Appl. No.: 12/831,081

(22) Filed: Jul. 6, 2010

Related U.S. Application Data
(60) Provisional application No. 61/223,643, filed on Jul. 7, 2009.

(51) Int. Cl. G06F 19/00; H04B 1/00; G06Q 30/00; G06F 7/00

(52) U.S. Cl. 705/26.41; 381/86; 701/22; 705/26.1; 701/29

(57) ABSTRACT

An audio system for an electrically powered vehicle includes a data storage unit, a processor for accessing the data storage unit and retrieving one of pre-recorded engine sounds, pre-recorded exhaust sounds, or one or more algorithms for reproducing engine sounds and exhaust sounds, an amplifier operably connected to the processor for amplifying one of an engine sound or exhaust sound, at least one outwardly directed speaker for generating one of an engine or exhaust sound, an interface between the processor and the one or more vehicle performance sensors for sensing a vehicle performance parameter, the interface configured to receive an input from the one or more vehicle performance sensors and transmit it to the processor, wherein the processor receives the input from at least one vehicle performance sensor and varies a sound parameter of an engine sound or exhaust sound projected by the speaker based on the performance parameter.

### CROSS-REFERENCE TO RELATED APPLICATIONS

This application claims benefit of U.S. Provisional Application Ser. No. 61/223,643, filed Jul. 7, 2009, and entitled VEHICLE AUDIO SYSTEM FOR PRODUCING SYNTHETIC ENGINE SOUND.

### TECHNICAL FIELD

The following disclosure relates to a vehicle audio system for electrically powered vehicles such as “plug-in” and hybrid vehicles, and in particular, audio systems and methods for generating synthetic engine and/or exhaust sounds.

### BACKGROUND

A combination of factors including ever-increasing energy costs, environmental concerns and the development of new battery technology has revived interest in electrically powered automobiles. “Plug-in” type electric vehicles rely solely on a battery powered electric motor to propel the vehicle. In some instances, “plug-in” electric vehicles may incorporate a small combustion engine that may be used to drive an electric generator to power the vehicle and/or recharge the battery when the batteries are depleted. Hybrid electric vehicles utilize both a combustion engine and an electric motor to propel the vehicle depending upon the vehicle's power demand under different conditions and other factors. Currently, electrically powered cars using “plug-in” and/or hybrid technology are available that have a driving range of 200 or more miles per day and performance rivaling or exceeding conventional vehicles powered with gasoline or diesel fuels. Increasing fuel costs have also driven demand for hybrid vehicles that rely on a combination of an electric drive motor with a conventional gas or diesel engine.

One characteristic of “plug-in” electrically powered vehicles is that the vehicles typically generate little or no engine sounds and no exhaust sounds. Similarly, hybrid electric vehicles produce little or no engine and exhaust sounds when operated in the electric mode. However, pedestrians and drivers are familiar with the engine and exhaust sounds generated by conventional automobiles. The sound generated by the engine and exhaust of a conventional diesel and gasoline-powered vehicle often alerts pedestrians, other drivers, pets and even wild animals to the approach of the vehicle. Further, the engine and exhaust sounds generated by a gasoline or diesel powered engine is appealing to a large number of drivers and consumers that equate the engine and exhaust sounds with power and performance.

Thus, while “plug-in” electric vehicles and hybrid vehicles may provide environmental, and in some instances economic benefits, the lack of engine and exhaust sounds presents certain drawbacks. From a safety aspect, it may be desirable to provide a means for such vehicles to generate a sound simulating a combustion engine to alert pedestrians, other drivers and animals to the presence and/or approach of an electrically powered vehicle. It may also be desirable to generate a sound simulating a combustion engine for aesthetic reasons, e.g., to appeal to those consumers that associate the sound of combustion engine with power and performance.

### SUMMARY

In one aspect, an electrically powered passenger vehicle includes an electric drive motor operatively coupled to one or more of the vehicle's wheels for rotating the vehicle's wheels to propel the vehicle and a battery pack for powering the electric drive motor. One or more operator controls are provided for steering, braking and controlling the speed of the vehicle. The vehicle further includes one or more sensors for monitoring one or more performance parameters of the vehicle such as speed, acceleration, motor load or transmission output. A data and/or media storage unit mounted in the vehicle includes one of pre-recorded engine sounds, pre-recorded exhaust sounds, or one or more algorithms for reproducing engine sounds and exhaust sounds. A processor is operably connected to the data storage unit for accessing the data storage unit and retrieving one of pre-recorded engine sounds, pre-recorded exhaust sounds, or one or more algorithms for reproducing engine sounds and exhaust sounds. In one embodiment, a cellular transceiver is connected to the processor whereby the processor can communicate with a third party service provider to download one of pre-recorded engine sounds, pre-recorded exhaust sounds, or one or more algorithms for reproducing engine sounds and exhaust sounds.

An amplifier is operably connected to the processor for amplifying one of an engine sound or exhaust sound. At least one speaker is connected to the amplifier for projecting one of engine sounds or exhaust sounds outside the vehicle. The processor receives an input generated by the sensor and varies a sound parameter of one of engine sounds or exhaust sounds projected by the speaker based on one or more performance parameters of the vehicle.

In one variation, the performance parameters may include one or more of the speed of the vehicle, acceleration of the vehicle, deceleration of the vehicle, speed of the drive motor and electric current draw of the drive motor. The sound parameters controlled with the processor may include volume and frequency and may be varied in a linear or non-linear manner based upon changes in the sensed vehicle performance parameters. In one embodiment, the electrically powered passenger vehicle includes at least one speaker oriented toward a front end of the vehicle and at least one speaker oriented toward the rear end of the vehicle wherein the speaker oriented toward the front of the vehicle is configured to project engine sounds outwardly from the vehicle and the speaker oriented toward the rear of the vehicle is configured to project exhaust sounds outwardly from the vehicle.

In another aspect, a method of providing prerecorded vehicle operating sounds or algorithms for reproducing vehicle operating sounds is disclosed. In accordance with the method, a third party service provider receives a transmission from a user device operated by a potential purchaser or user with a server connected to a public or private computer network. The service provider electronically transmits selection information to the potential purchaser or user with the server over the public or private network, the selection information including vehicle sound selections including engine and exhaust sounds and/or an algorithm for producing such sounds. The transmitted selection information may include a prompt or otherwise enable the potential purchaser to preview, e.g., listen to, selected sounds. The service provider may receive an electronic transmission from the user device operated by the potential purchaser selecting one or more engine or exhaust sounds. If the potential purchaser or user elects to hear a preview of one or more selected sounds, the server electronically transmits one of a segment of a prerecorded engine or exhaust sound or an algorithm for producing an engine or exhaust sound to the user device via the public or private network. The user device may be permanently mounted in a “plug-in” or hybrid vehicle or may be a hand held wireless device.

If the potential customer or user elects to purchase and/or receive one or more vehicle sound selections, the service provider receives an electronic transmission from the user device confirming that the potential purchaser wishes to purchase one of a selected prerecorded engine or exhaust sounds or an algorithm for producing a selected engine or exhaust sound. The service provider may then electronically transmit a prompt to the user device enabling the potential purchaser to select a payment type. After receiving an electronic transmission from the user device indicating a selected payment type, the service provider may then electronically transmit a request to a third party to confirm payment information received from the potential purchaser and/or to debit the purchaser's account with the third party for the purchase price of the selected sound(s) or algorithms. If the potential purchaser has an account with the service provider, the potential customer's account and/or payment may be confirmed by the third party service provider. After receiving confirmation or verification of the payment information, or confirming the purchaser's account information, the third party service provider may electronically transmit one of the selected prerecorded engine or exhaust sounds or an algorithm for producing a selected engine or exhaust sound to the user device.

In one embodiment the user device is a cellular transceiver and the selection information may be a screen display. The screen display information is transmitted to the potential purchaser with the server connected to a public or private network. The display information may further include sound selections including one or more of wind sounds, road sounds and animal deterrent sounds for display on the user device. In other embodiments, the selection information may be in the form of a pre-recorded audio menu.

In another aspect, an audio system for an electrically powered vehicle includes a data storage unit including one of pre-recorded engine, exhaust, road, wind and/or animal deterrent sounds, or one or more algorithms for reproducing such sounds. The audio system further includes a processor for accessing the data storage unit and retrieving one of pre-recorded sounds, or one or more algorithms for reproducing the sounds. The processor is operably connected to an amplifier for amplifying one or more of an engine sound, exhaust sound, wind sounds, road noise, or animal deterrent sounds. At least one outwardly directed speaker mounted outside of the passenger compartment of the vehicle is connected to the amplifier for reproducing a selected vehicle sound such as an engine or exhaust sound. The audio system may include a cellular transceiver connected to the processor such that the processor can communicate with a third party service provider to receive and store one of pre-recorded engine sounds, pre-recorded exhaust sounds, or one or more algorithms for reproducing engine sounds and exhaust sounds.

The audio system includes an interface between the processor and one or more vehicle performance sensors for sensing a performance parameter of the vehicle. The interface is configured to receive an input from one or more vehicle performance sensors and transmit it to the processor. The processor receives an input generated by at least one performance sensor and varies a sound parameter of one of engine sounds, exhaust sounds or other sounds projected by the speaker based on a performance parameter of the vehicle. In one embodiment, the performance parameters include one or more of the speed of the vehicle, acceleration of the vehicle, deceleration of the vehicle, speed of the drive motor, wheel speed and electric current draw of the drive motor. The sound parameters may include the volume and frequency of sounds generated by the audio system.

In one variation, the audio system includes at least one speaker oriented toward a front end of the vehicle and at least one speaker oriented toward the rear end of the vehicle. The speaker oriented toward the front of the vehicle may be configured to project engine sounds outwardly from the vehicle and the speaker oriented toward the rear of the vehicle may be configured to project exhaust sounds outwardly from the vehicle. In one embodiment, the front and rear speakers may be driven on separate channels. In other embodiments, an electronic mixer or similar device may be used to separate and/or combine engine, exhaust and other sounds based on frequency.

In yet another aspect, a method of producing vehicle sounds associated with a combustion engine includes receiving an electronic transmission from a third party service provider, the electronic transmission including selection information for at least one of pre-recorded engine sounds, pre-recorded exhaust sounds, or one or more algorithms for reproducing engine sounds and exhaust sounds. After the customer or user receives the selection information, he or she electronically transmits a selection from one of prerecorded engine sounds, pre-recorded exhaust sounds, or one or more algorithms for reproducing engine sounds and exhaust sounds. In one embodiment, the customer receives and listens to a preview of the selected engine or exhaust sounds.

In order to receive the selected engine or exhaust sounds, the customer electronically transmits payment and/or account information to the third party service provider. The customer may then receive an electronic transmission including the one or more of pre-recorded engine sounds, pre-recorded exhaust sounds, or one or more algorithms for reproducing engine sounds and exhaust sounds. The one or more of prerecorded engine sounds, pre-recorded exhaust sounds, or one or more algorithms for reproducing engine sounds and exhaust sounds are stored on a storage unit for retrieval.

The stored sounds, or algorithms for producing the sounds, may be retrieved from the storage unit with an audio system of an electrically powered passenger vehicle to reproduce one or more of an engine sound or exhaust sound. The audio system receives an input generated by at least one vehicle performance parameter sensor and varies a sound parameter produced by the audio system based on the performance parameter of the vehicle. The sound parameters may include volume and frequency. The vehicle performance parameters may include one or more of the speed of the vehicle, acceleration of the vehicle, deceleration of the vehicle, speed of the drive motor and amperage of the electric current drawn by the drive motor. Road noises, wind noises and animal deterrent noises may also be reproduced and varied with changes in the vehicle performance parameters.

### BRIEF DESCRIPTION OF THE DRAWINGS

For a more complete understanding, reference is now made to the following description taken in conjunction with the accompanying Drawings in which:

FIG. 1 illustrates an electrically powered vehicle including an audio system for generating engine and/or exhaust sounds according to the disclosure;

FIG. 2 is a schematic of an audio system and related components for use with an electrically powered vehicle;

FIG. 3 is an exemplary screen display for selecting sounds for an electrically powered vehicle;

FIG. 4 is a graph illustrating possible relationships between the speed of an electrically powered vehicle and engine and/or exhaust sounds generated with an audio system;

FIG. 5 is a graph illustrating possible relationships between acceleration/deceleration of an electrically powered vehicle and engine and/or exhaust sounds generated with a vehicle audio system;

FIG. 6 is a graph illustrating possible relationships between the motor speed or vehicle speed of an electrically powered vehicle and the frequency or pitch of engine and/or exhaust sounds generated with a vehicle audio system;

FIG. 7 is a graph illustrating possible relationships between the motor speed or vehicle speed of an electrically powered vehicle and the frequency or pitch of engine and/or exhaust sounds generated with a vehicle audio system;

FIG. 8 is a graph illustrating a pulsed or interrupted volume or frequency of engine and/or exhaust sounds generated with a vehicle audio system according to the disclosure;

FIG. 9 is a schematic representation of a control consol for an audio system for generating engine or exhaust sounds for an electrically powered vehicle;

FIG. 10 illustrates a method for providing engine, exhaust and other sounds for use with an electrically powered vehicle; and

FIG. 11 illustrates a method for producing engine, exhaust and other sounds with an electrically powered vehicle.

### DETAILED DESCRIPTION

Referring now to the drawings, wherein like reference numbers are used herein to designate like elements throughout, the various views and embodiments of a vehicle audio system for producing synthetic engine sound are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

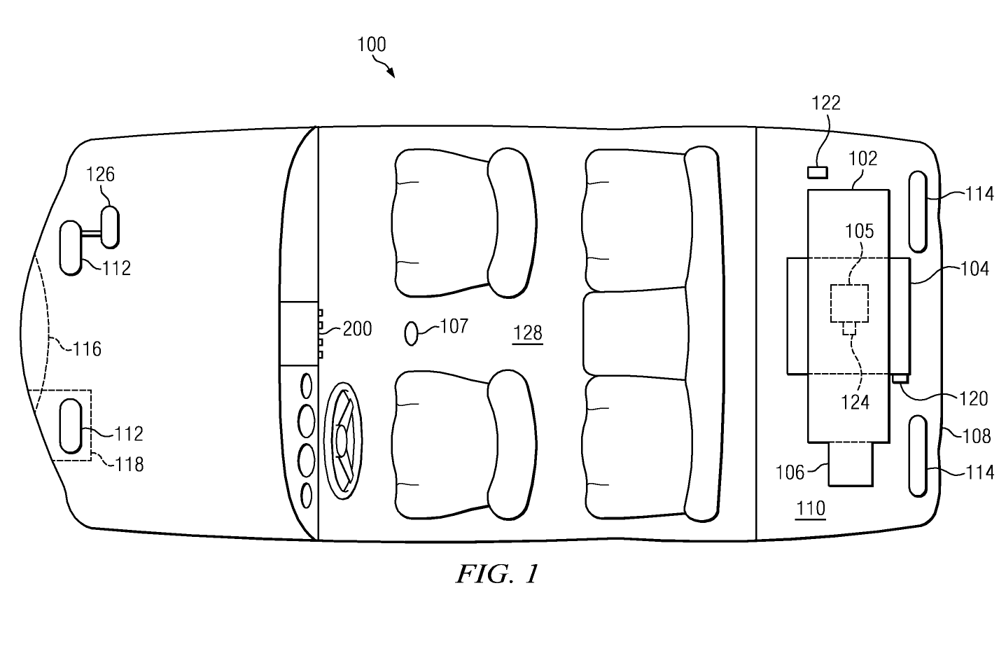

FIG. 1 illustrates an electrically driven vehicle 100 employing an audio system for generating synthetic engine and/or exhaust sounds according to the disclosure. In one embodiment, electrically powered vehicle 100 includes a battery or battery pack 102, an electric drive motor 104 and a motor controller package 106. As used herein, an “electrically powered vehicle” or “electrically driven vehicle” includes plug-in and hybrid passenger vehicles (e.g. not toys), having one or more electric motors that supply rotary power to the vehicle's wheels to propel the vehicle at highway speeds, for example up to 50 miles per hour and faster. As illustrated, an electric drive motor 104 may be mounted adjacent the rear 108 of the vehicle with battery pack 102 and motor controller package 106 mounted in a compartment 110 above the electric drive motor. In other variations, battery pack 102, electric drive motor 104 and motor controller package 106 may be mounted at alternative positions in the vehicle 100, for example in the front of the vehicle or in a mid-body motor configuration or at different locations in the vehicle. In other variations, vehicle 100 may include a manual or automatic transmission 105 for transmitting power from electric drive motor 104 to a drive shaft or axle of the vehicle. Motor controller 106 is connected to operator controls generally designated 107 for energizing the electric drive motor 104 and controlling the speed of the motor and vehicle 100.

Referring still to FIG. 1, in one embodiment, vehicle 100 is equipped with one or more front speakers 112 and one or more rear speakers 114. Front speakers 112 may be mounted behind the grill 116 of vehicle 100 or in another location such that the front speakers project sound primarily in a forward direction. Rear speakers 114 may be mounted at the rear 108 of vehicle 100, for example behind the rear bumper, to project sound primarily in a rearward direction. Speakers 112, 114 may be outwardly directed and mounted outside of the passenger compartment 128 of electrically powered vehicle 100. Other speaker configurations are possible, such as speakers mounted on the sides of vehicle 100. Speakers 112, 114 may be mounted in an environmentally protected enclosure 118 to protect the speakers from moisture and dirt. Speakers 112, 114 may be rotatably mounted such that the position and direction of the speakers may be adjusted manually or by means of an actuator 126 (one shown) such as an electric stepper motor or linear actuator. In other embodiments, speakers 112, 114 may be configured for outside use, e.g., provided with waterproof enclosures. Speakers 112 and 114 may be selected to have the same or different frequency response characteristics. For example, front speakers 112 may have a mid-range frequency response or a full range frequency response to reproduce or simulate engine noise while rear speakers 114 may have low-range frequency or full frequency response characteristics to reproduce or simulate exhaust noise. Speakers 112, 114 may be driven with an audio system generally designated 200 to reproduce or simulate engine and/or exhaust sounds.

Vehicle 100 may be provided with a first sensor 120 to monitor the speed (rpm) of electric drive motor 104. A second sensor 122 may be provided to monitor the speed of the vehicle (mph) based on wheel or axle revolutions. A third sensor 124 may be provided to monitor the speed or output of transmission 105. The output of sensors 120, 122 and 124 may be connected to audio system 200 to enable the system to adjust the frequency, pitch or volume of engine and/or exhaust sounds reproduced or simulated by audio system 200 based on the speed of electric drive motor 104 and/or the vehicle speed. In other embodiments, sensors may be provided to monitor the amperage or current load drawn by electric drive motor 104 and the output of transmission 105.

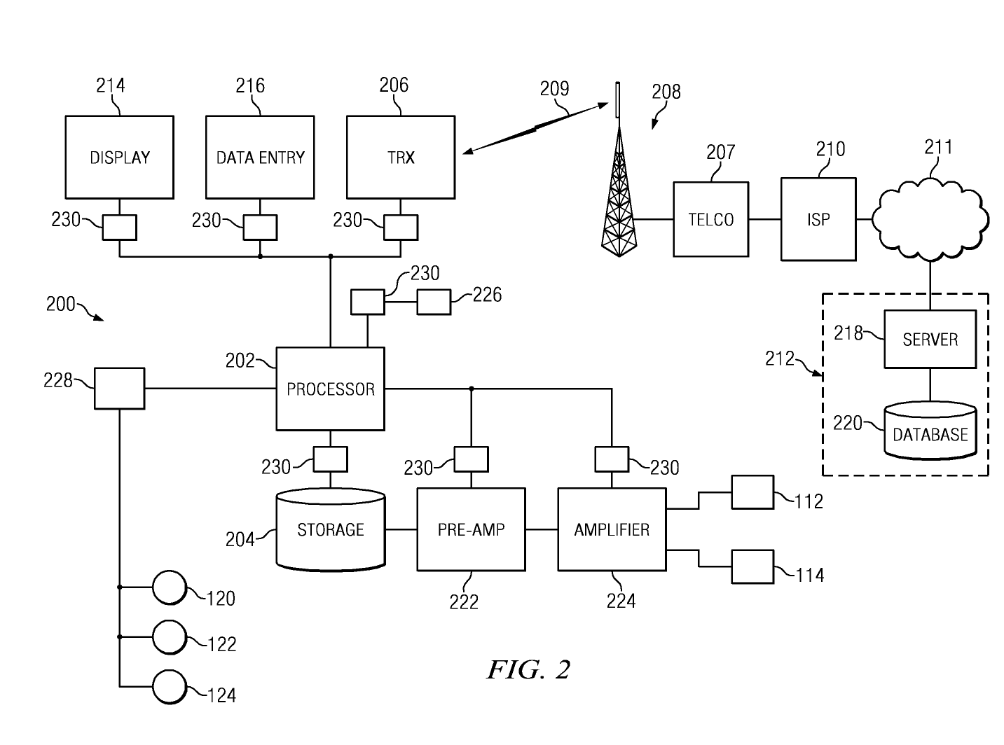

FIG. 2 is a schematic representation of one embodiment of audio system 200 and related components for simulating engine and/or exhaust sounds. In the illustrated embodiment, system 200 includes a processor 202 for controlling various functions of the audio system. Processor 202 is operatively connected to an associated data and/or media storage unit 204. Audio system 200 may also include a display 214 and a data entry feature 216 such as a keyboard, touch screen or a voice recognition feature. In one embodiment, display 214, data entry feature 216 and controls such as switches or knobs 226 may be mounted in the dashboard of vehicle 100 or in another location accessible to the operator of the vehicle.

Audio system 200 may also include components such as pre-amplifier 222, amplifier 224 as well as other components such as a radio frequency receiver for receiving am and fm radio frequency transmissions, a media player such as a DVD or CD player, mixer(s), equalizer(s), volume, bass and treble controls and other components typically used in automotive audio systems. Audio system 200 may include a digital, analog or analog/digital interface 228 for connecting processor 202 to one or more of sensors 120, 122, 124 to provide an input reflecting a performance parameter of vehicle 100 such as vehicle speed, acceleration, motor current draw, transmission output or other similar parameter. System 200 may further include one or more analog, digital or analog/digital interfaces 230 to connect processor 202 to data and/or media storage unit 204, cellular transceiver 206, preamplifier 222, amplifier 224, display 214, data entry feature 216 and controls such as switches or knobs 226.

Referring still to FIG. 2, processor 202 may be operatively connected to a cellular transceiver 206, which may be configured to transmit and receive data, voice, and media transmissions over a wireless interface 209 with cellular telephone network generally designated 208. In one embodiment, cellular transceiver 206 may be permanently mounted in vehicle 100. In other embodiments, cellular transceiver 206 may comprise a portable device such as a cellular handset, a personal computer or another user device having hardware and software for communicating over a cellular network. The portable device may communicate with the processor via an interface such as a USB connector or a wireless interface. Cellular network 208 provides a communications link between transceiver 206 and a cellular telephone company 207, which may connect transceiver to an Internet service provider 210.

Internet service provider 210 provides a communications link with a third party service provider 212 via a private or public network such as the Internet 211. In other embodiments, third party service provider 212 may be linked directly to cellular network 208. In one embodiment, third party service provider 212 maintains a server 218 and an associated database 220. As used herein, the term “server” refers to a computer that delivers information and/or software to other devices via a private or public network such as the Internet. In one embodiment, server 218 may communicate with other devices using a protocol such as Hyper Text Transfer Protocol (http) which enables transmission of information in the form of text documents coded in a standard markup language such as Hyper Text Markup Language (HTML).

A plurality of pre-recorded engine and/or exhaust sounds, or algorithms for producing engine and exhaust sounds, may be stored on database 220. Wind sounds and road sounds generated by the tires of a vehicle may also be incorporated into stored vehicle sounds. Pre-recorded engine and exhaust sounds, wind sounds, road sounds (or algorithms for producing such sounds) associated with different types of vehicles and/or engines may be stored on database 220. For example, engine and exhaust sounds associated with different types of sports cars, “muscle” cars, different types of racing cars, turbine powered cars, jet engines and other vehicles, engines and exhaust systems may be recorded and stored on database 220. Pre-recorded engine and exhaust sounds for individual vehicles may be stored on multiple tracks such that the pre-recorded engine and exhaust sounds may be individually accessed, processed and manipulated to produce the desired results.

In one embodiment, a consumer may access cellular network 208 using data entry feature 216 and cellular transceiver 206 to connect to third party service provider 212 via the cellular network 208 and Internet 211. Server 218 may respond by transmitting information enabling processor 202 to display one or more preformatted screens with display 214. The preformatted screen or screens enable a consumer to select and purchase prerecorded engine and/or exhaust sounds or an algorithm for producing such sounds.

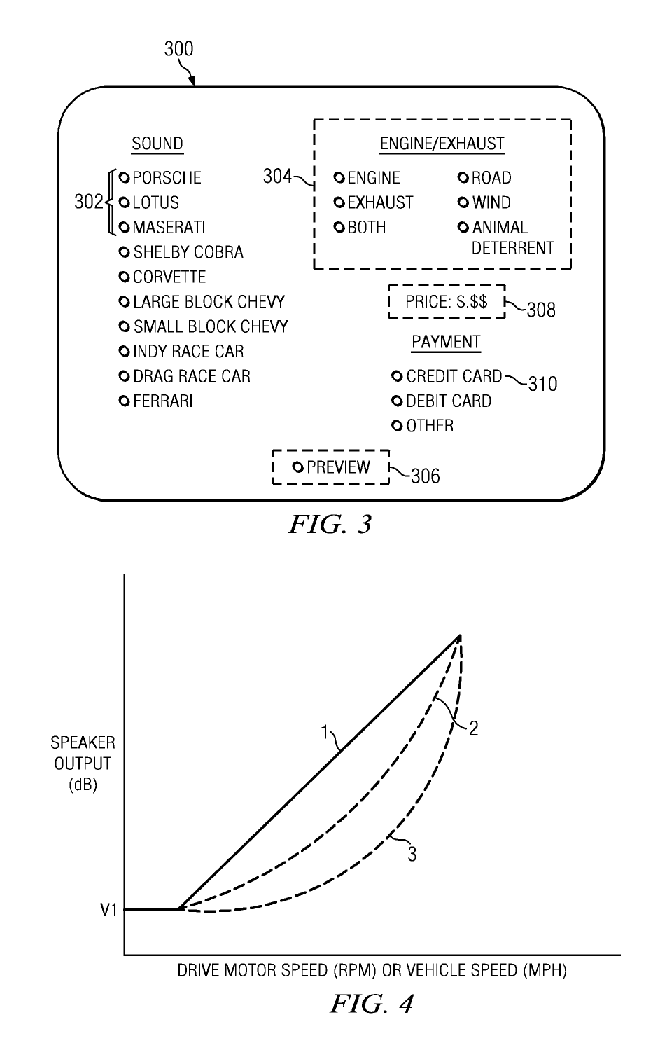

FIG. 3 is an exemplary screen display 300 enabling a consumer or user to purchase and download engine and/or exhaust sounds for use with electrically powered vehicles such as vehicle 100. As illustrated, screen display 300 lists a variety of engine and/or exhaust sounds associated with different automobiles from which the consumer may choose, for example, using data entry feature 216 to select the name 302 of a particular vehicle or vehicle or engine type. The vehicle sounds may be prerecorded actual sounds and/or algorithms for producing or manipulating the sounds. After selecting the vehicle name or type the consumer may use an engine/exhaust portion 304 of display 300 to select the engine sound associated with the vehicle, the exhaust sound associated with the vehicle or both. The consumer may use display 300 to select an engine sound associated with one type of vehicle and an exhaust sound associated with another type of vehicle. Screen display 300 may also include selections for other sounds, or algorithms for simulating sounds, such as road sounds, wind sounds, and sounds for frightening or otherwise deterring animals from entering the path of a vehicle.

Referring still to FIG. 3, in one embodiment, the consumer may select a preview function 306. When the customer selects preview function 306, server 218 may respond with a transmission including a segment of the selected vehicle engine or exhaust sound or algorithm. The transmitted preview of the selected sound may be directed to speakers 112 and/or 114 to enable the consumer to decide whether he or she wishes to purchase the selected prerecorded engine or exhaust sounds or algorithm for reproducing the sound. The consumer may also select a combination of sounds, e.g., an engine sound with, for example, one or more of an exhaust sound, road noise and wind sounds and/or an algorithm for producing such sounds.

Referring to FIGS. 2 and 3, after the consumer has selected an engine and/or exhaust sound, server 218 may transmit a purchase price 308 for inclusion in display 300 if the purchase price has not already been displayed to the consumer. The consumer may then specify a payment option 310 such as a credit card or debit card. If the consumer has an account with third party service provider 212, the customer may enter an account number and/or password. After the consumer has entered the information necessary to complete payment to the third party service provider 212, server 218 accesses the selected engine and/or exhaust sounds, or algorithm for producing the sounds, on database 220 and transmits the sounds or algorithm(s) to processor 202 via the Internet and cellular network 208. The transmitted sounds or algorithm(s) may then be stored on data and/or media storage unit 204.

Referring again to FIGS. 1 and 2, in one embodiment, when electric drive motor 104 of vehicle 100 is energized, processor 202 accesses data storage unit 204 to direct stored engine and/or exhaust sounds to pre-amplifier 222. The output from pre-amplifier 222 is directed to amplifier 224 which powers speakers 112 and 114. In one embodiment, speakers 112 and 114 are on separate audio channels such that speakers 112 reproduce engine sounds while speakers 114 reproduce exhaust sounds. In other embodiments, a digital or analog mixer or similar device may be used to separate signals to speakers 112, 114 such that engine sounds are generated by front speakers 112 and exhaust sounds are generated by rear speakers 114.

Turning to FIG. 4, in one embodiment, speakers 112 and 114 may be controlled to output a base volume of sound “V1.” “V1” may be selected to generate a sound level that is audible over a predetermined distance, for example fifty feet. In this manner, other drivers, pedestrians and pets would be alerted to the presence of vehicle 100 even if the vehicle was stopped at a stop sign or red light. In other embodiments, speakers 112 and 114 are not energized until vehicle 100 begins to move and are de-energized when the vehicle comes to a stop.

Referring to FIGS. 2 and 4, the power to speakers 112 and 114 may be controlled with processor 202 such that the sound output of the speakers varies with a vehicle performance parameter such as vehicle speed. In one embodiment, processor 202 increases or decreases the power to speakers 112, 114 to increase the engine and/or exhaust sounds generated by the speakers proportionally with the speed of electric drive motor 104 as measured with motion sensor 122 (FIG. 1) which measures wheel or axle speed. Alternatively, processor 202 may control the power to speakers 112, 114 based on an input from sensors 120 and/or 124 that detect the revolutions per minute of electric drive motor 104 or the power output of transmission 105. In other embodiments, the power to speakers 112, 114 may be increased or decreased proportional to the electrical current draw of electric drive motor 104. Thus, as illustrated, the volume (dB) and frequency (Hz) of sound generated by speakers 112 and/or 114 increases or decreases as the speed of the vehicle increases or the rpm of electric drive motor 104 increases. In one embodiment, the volume of sound increases linearly with speed as illustrated by line 1. In other embodiments, the volume of sound increases non-linearly as illustrated by lines 2 and 3. In still other embodiments, the driver may select between different sounds vs. speed profiles (e.g., lines 1, 2 or 3) by means of a selector switch (not shown) connected to processor 202. Processor 202 may use pre-programmed algorithms or instructions stored on data storage unit 204 to vary the volume and pitch of engine and/or exhaust sounds generated by speakers 112, 114.

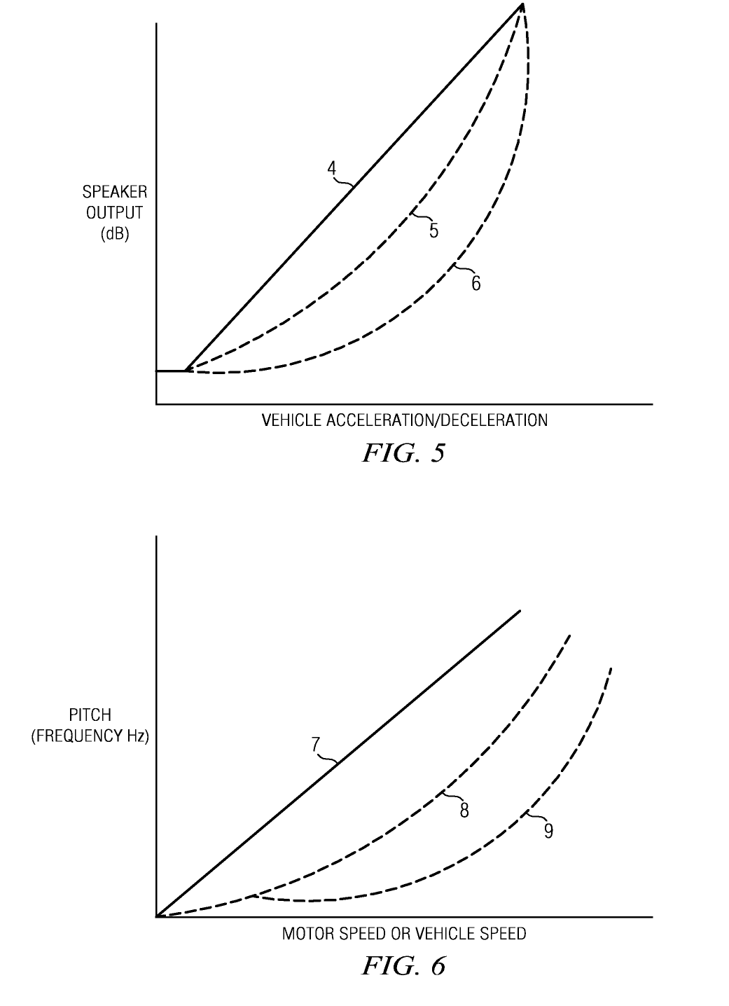

Referring to FIG. 5, the power to speakers 112, 114 may be controlled to increase or decrease the volume of sound generated proportionally to the vehicle's acceleration. In one variation, the volume of sound may be a linear function of the vehicle's acceleration and or deceleration as indicated by line 4, or alternatively may be a non-linear function of the vehicle's acceleration or deceleration as illustrated by lines 5 and 6. Further, the volume and pitch may be varied depending upon whether the vehicle is accelerating or decelerating to simulate the different sounds generated by a conventionally fueled vehicle as it accelerates versus when it decelerates. In still other embodiments, the driver may select between different sound vs. acceleration profiles (e.g., lines 4, 5 or 6) by means of a selector switch (not shown) connected to processor 202.

Referring to FIG. 6, the tone or pitch of the engine and/or exhaust sounds generated by speakers 112, 114 may vary linearly with the speed of vehicle 100, acceleration and deceleration of the vehicle, the speed of electric drive motor 104, the electric load of electric drive motor 104, the output of transmission 105 or the position of a manual speed controller used by the driver. This effect may be linear as illustrated by line 7, or non-linear as illustrated by lines 8 and 9. In still other embodiments, the driver may select between different pitch vs. speed profiles (e.g., lines 7, 8 or 9) by means of a selector switch (not shown) connected to processor 202.

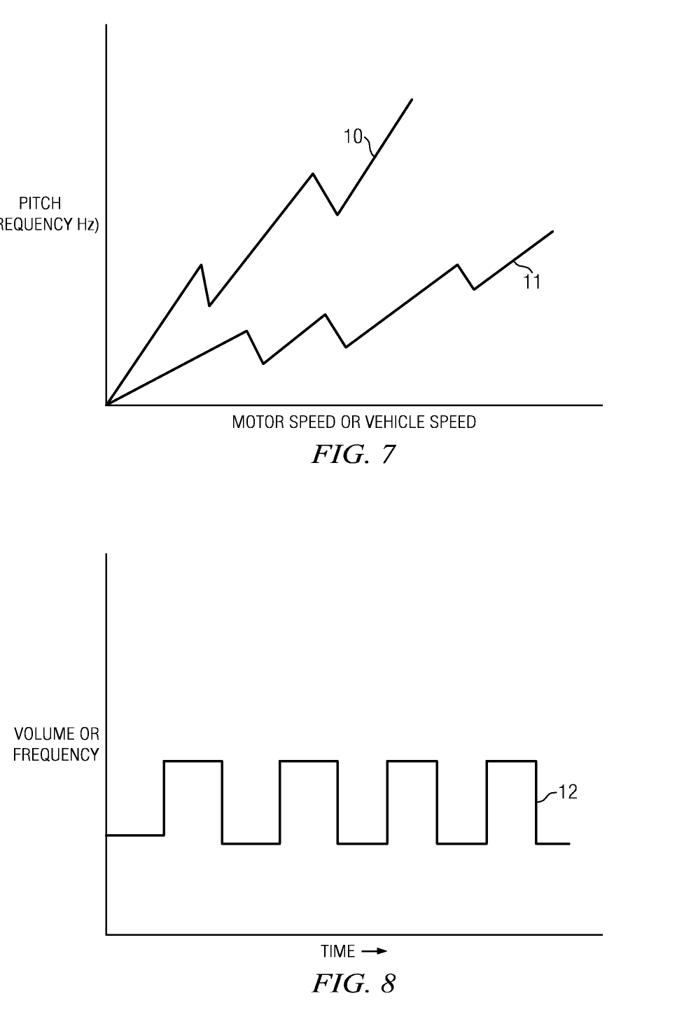

Turning to FIG. 7, as illustrated by lines 10 and 11, the volume, tone or pitch of engine and/or exhaust sounds created by speakers 112 and 114 may be varied in a “stepped” fashion as a function of the speed or acceleration of vehicle 100 to simulate the sound of a conventionally fueled vehicle as it is shifted, either manually or by means of an automatic transmission. This effect may be accomplished with processor 202 using pre-programmed logic and instructions resident on data storage device 204. For example, processor 202 may step the tone or pitch of engine or exhaust sounds up or down when the vehicle reaches predetermined speeds such as 20, 30 and 40 miles per hour. In other embodiments, processor 202 may step the tone or pitch of engine or exhaust sounds up or down based on the current draw of electric drive motor 104 or the power output of transmission 105 to simulate the sound of a conventionally fueled vehicle as it is shifted, either manually or by means of an automatic transmission.

Turning to FIG. 8, in yet another variation, the volume and/or frequency of sound generated by speakers 112, 114 may be pulsed or interrupted to create different audible effects as illustrated by line 12. The pulsing or interrupting effect may be accomplished with processor 202 using pre-programmed logic resident on data storage device 204 to control the power to speakers 112, 114. The pulsing or interrupting effect may be used, for example, to simulate the exhaust sounds of an idling combustion engine running at low revolutions per minute (rpm).

As will be appreciated, the sound parameters illustrated and described in connection with FIGS. 4-8 may be combined and manipulated to produce the desired sound effects. One or more pre-recorded engine and/or exhaust sounds, pre-recorded wind and road noise stored on data storage device 204 may be manipulated or extrapolated by means of algorithms, preprogrammed logic and/or manual operator controls to simulate engine and exhaust sounds based on vehicle speed, acceleration, deceleration, motor load and other vehicle performance parameters. Pre-recorded engine and exhaust sounds, pre-recorded wind and road noise may be combined to produce the desired sound effects.

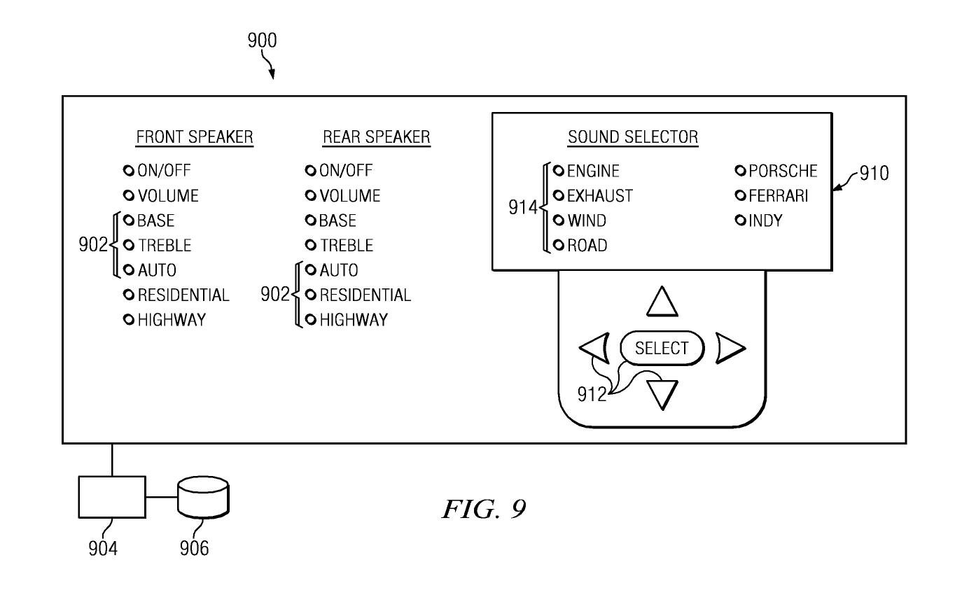

FIG. 9 illustrates an operator control consol 900 for controlling audio system 200 of electrically powered vehicle 100. In one embodiment, control consol 900 includes manual controls 902 for turning the front and rear speakers 112, 114 of vehicle 100 (FIG. 1) on and off, increasing or decreasing the volume of sounds generated by the speakers and controls for adjusting the base and treble of the speakers. Controls 902 may include an auto setting wherein a controller or processor 904 controls some or all of the audio settings including frequency and volume based on pre-programmed instructions stored in an associated data storage device 906 and/or the input from sensors such as sensors 120, 122 and 124 of FIG. 1. Controller or processor 904 may be the same as, or separate from, processor 202 of FIG. 2.

Manual controls 902 may include residential and highway settings whereby the operator of the vehicle may select pre-programmed sound parameters such as volume or frequency based on the location of vehicle 100. For example, the operator of vehicle 100 may wish to increase or decrease the volume or frequency of sound generated by speakers 112, 114 depending upon the environment. In a residential environment, the operator of vehicle 100 may wish to increase the volume of sound produced by front speakers 112 relative to rear speakers 114 to alert pedestrians and pets that the vehicle is approaching. Controls 902 may be knobs, buttons, switches or be incorporated into a touch screen. As illustrated, separate controls 902 may be provided for front and rear speakers 112, 114.

Control consol 900 may include a display 910, which may be the same as, or separate from, display 214 of FIG. 2. Display 910 may be a touch screen or be provided with keys or buttons 912. In one embodiment, when audio system 200 is turned on, display 910 may display one or more selections 914 for engine, exhaust, wind and road sounds. Display 910 may also display selections for sounds corresponding to different vehicle types. The operator of vehicle 100 may use keys 912 to select engine, exhaust, road and wind sounds as well as sounds corresponding to different types of vehicles. Processor or controller 904 accesses data storage device 906 to retrieve the selected sounds which are then reproduced with speakers 112, 114 as described in connection with FIG. 2. In one embodiment, data storage device 906 is the same as data storage device 204 of FIG. 2 and includes pre-recorded sounds or algorithms for producing the sounds that have been purchased and downloaded as described in connection with FIG. 3.

In one embodiment, control consol 900 may be permanently mounted at a location in electrically powered vehicle 100 such as the vehicle dashboard or a similar location readily accessible to the operator of the vehicle. In other embodiments, controls 902, and/or display 910 may be incorporated in a hand-held wireless device which communicates with controller 904 via a wireless radio frequency interface.

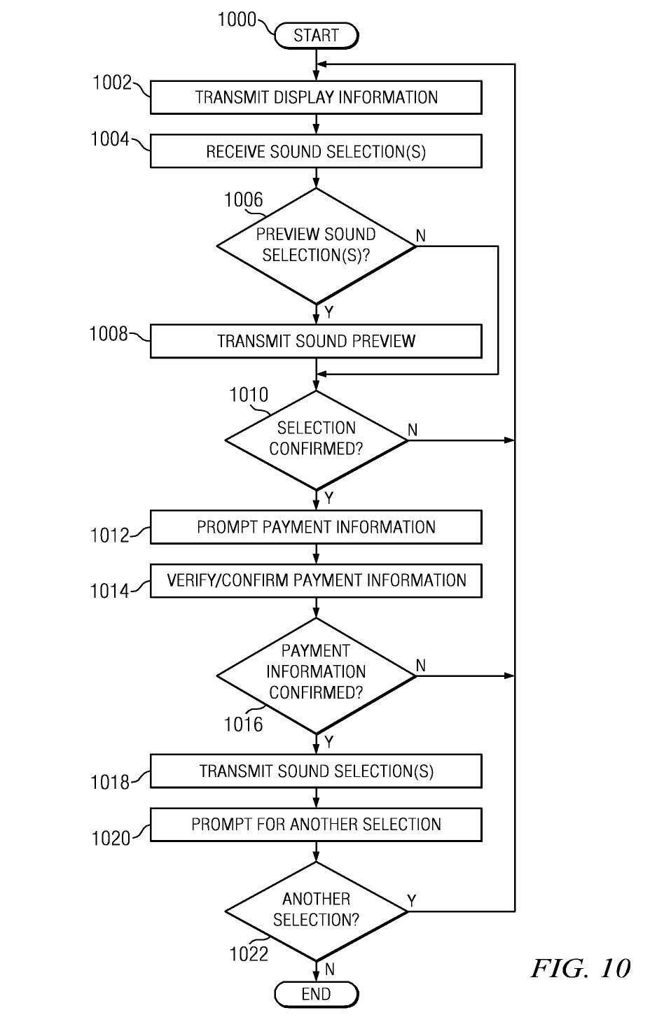

FIG. 10 illustrates a method of providing engine and exhaust sounds to be used with an electrically powered vehicle. Referring now to FIGS. 2 and 10, the process begins at step 1000 when a consumer opens a call to third party service provider 212 and is connected to server 218. At step 1002, server 218 accesses database 220 and electronically transmits display information to processor 202. The transmitted display information may be a web page and/or in the form of text documents coded in a standard markup language such as Hyper Text Markup Language (HTML) which are displayed on display 214. The transmitted display may be the same as, or similar to, selection screen 300 of FIG. 3 and includes options allowing the consumer to select from a variety of sounds including engine sounds, exhaust sounds, road and wind noise and animal deterrent sounds. Animal deterrent sounds may include high-frequency sounds or noises selected to deter animals from entering the path of the vehicle or moving out of the path of the vehicle. Such sounds are typically inaudible to the human ear. The selection display or screen may also include purchase price(s) for the various sounds.

After the consumer has made his or her selections and transmitted the selections to third party service provider 212, the transmitted selections are received with server 218 at step 1004. Server 218 may prompt the consumer to determine if the consumer wishes to hear a preview of the selected sounds at step 1006. If the consumer responds with a request for a preview, server 218 may transmit a brief segment or segments of the selected pre-recorded sounds at step 1008 for review by the consumer. The transmitted sound segment may be encrypted or otherwise protected to insure that it is not re-recorded or otherwise stored.

After listening to the sound preview, the consumer may be prompted at step 1010 to confirm his or her selection(s). If the consumer fails to confirm the selection, the process returns to step 1002 and a cleared selection screen is displayed. If the consumer confirms the selection(s), server 218 transmits a prompt for the consumer to enter payment information. The payment information may include the consumer's name and address, a credit or debit number or other information. If the consumer has an account with the third party service provider 212, the information may be a password and the consumer's account number or similar identifying information.

After the consumer has transmitted the requested payment and/or account information, the information is verified or confirmed at step 1014. Server 218 may open a connection to a bank, credit card processing center or another service provider and transmit the consumer's credit or debit card number, name, address and any other information required for verification of the payment information. If the consumer has an account with third party service provider 212, server 218 may access database 220 to verify the account information and store information regarding the order for further processing such as debiting the consumer's account and/or generating a bill.

If the payment information is not verified or confirmed at step 1016, the process returns to step 1002 and a cleared selection screen is again displayed. Alternatively, an error message may be transmitted to the consumer. If the payment information is confirmed, server 218 accesses database 220 to retrieve the selected prerecorded engine, exhaust or other sounds and/or algorithms for reproducing or manipulating the sounds. The selected sounds and/or algorithms are then transmitted to the consumer at step 1018. At step 1020, server 218 may transmit a prompt to the consumer to determine if the consumer wishes to make another selection. If the consumer elects to make another selection at step 1022, the process returns to step 1002 and a cleared selection screen is displayed. Alternatively, if the consumer does not wish to make further selections, the process is terminated at step 1024 and the connection between server 218 and processor 202 is closed.

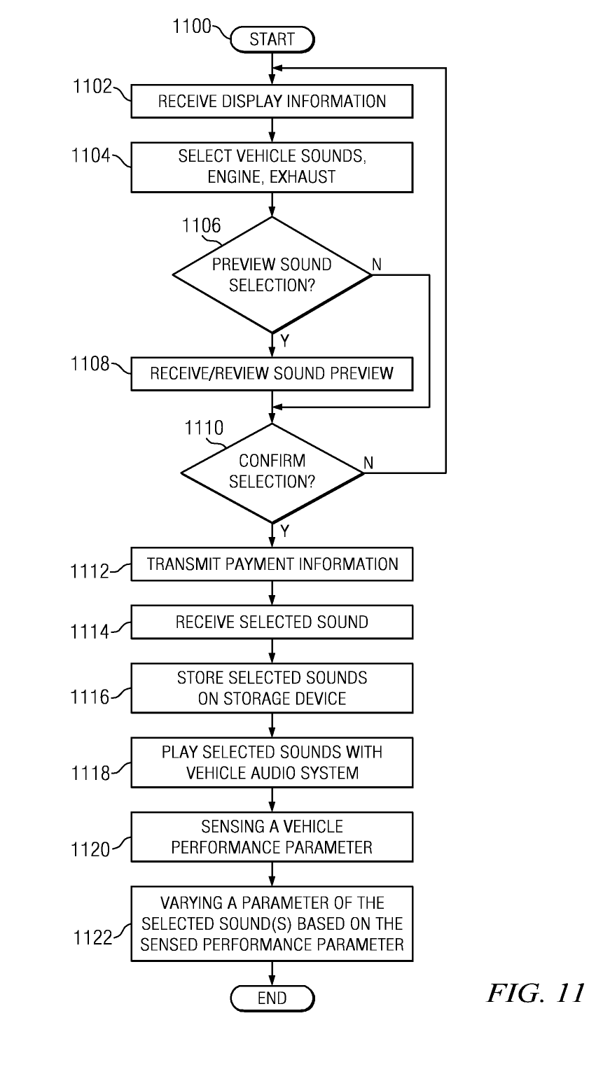

FIG. 11 is a flowchart illustrating a method for producing engine, exhaust and other sounds with an electrically powered vehicle 100. Referring to FIGS. 2 and 11, the process begins at step 1100 when a consumer uses cellular transceiver 206 to open a call to third party service provider 212 via wireless interface 209 with cellular network 208, cellular telephone company 207 and Internet service provider 210. In some instances, cellular telephone company 207 and Internet service provider 210 may be the same entity. In other instances, a customer may open a call directly to third party service provider 212 over the cellular network.

Referring still to FIG. 11, after the call has been opened, server 218 may transmit display information such as selection screen 300, which is received by the customer at step 1102. The transmitted display information may be a web page and/or in the form of text documents coded in a standard markup language such as Hyper Text Markup Language (HTML) which are displayed on display 214. The transmitted display may include options allowing the consumer to select from a variety of sounds including engine sounds, exhaust sounds, road and wind noise and animal deterrent sounds. The selection display or screen 300 may also include purchase price(s) for the various sounds.

At step 1104, the customer may use the display information or selection screen 300 and data entry feature 216 to then select one or more sounds associated with a conventionally fueled vehicle such as engine and exhaust sounds, wind sounds and road noise. In one embodiment, the customer may also elect to receive a preview of one or more selected sounds at step 1106. If the customer elects to receive a preview of one or more selected sounds, the preview is transmitted to the customer and the customer may listen to the preview at step 1108. The preview may be in the form of a prerecorded sound, and/or an algorithm for producing or manipulating a prerecorded sound.

At step 1110, the customer may confirm his or her wish to purchase the selected the sounds. If the customer declines to confirm a purchase of the selected sound or sounds, the process returns to step 1102 and a cleared selection screen is received by the customer. If the customer confirms purchase of the selected sounds, the customer may enter and transmit payment and/or account information at step 1112. Assuming that the customer's payment information is accepted, the selected sounds and/or algorithms for producing, manipulating or enhancing such sounds are transmitted by server 218 and received by processor 202 at step 1114. The prerecorded sounds, algorithms for producing, manipulating or enhancing such sounds may be stored on data and/or media storage unit 204 at step 1116 and played with vehicle audio system 200 at step 1118.

Referring to FIGS. 2 and 11, at step 1120 a vehicle performance parameter is sensed with a sensor such as sensors 120, 122 and 124 of FIGS. 1 and 2. The vehicle performance parameters may include the speed of the vehicle 100, acceleration of the vehicle, deceleration of the vehicle, speed of the electric drive motor 104 and the electric current draw of the electric drive motor. An output of one or more of sensors 120, 122, 124 or other sensor is input to processor 202 via an analog, digital or analog/digital interface 228. At step 1122 processor 202 may use stored algorithms or preprogrammed logic resident on storage unit 204 to vary a sound parameter such as volume or frequency to vary the sounds generated by audio system 200 with changes in the sensed vehicle performance parameters.

Although the methods described in connection with FIGS. 10 and 11 have been described in connection with the use of a visual display, it will be appreciated that the methods may be practiced without such a display. For example, selection information may be in the form a pre-recorded audio menu that enables a customer to select and/or preview selected sounds and transmit payment information without the use of a display. In some embodiments, a customer may open a call directly to third party service provider 212, listen to a prerecorded menu of sounds and make selections using, for example a cellular handset. The cellular handset may be linked to processor 202 and/or data and/or media storage unit 204 of FIG. 2 by means of an interface such as a USB connector or a wireless interface for downloading and storing engine, exhaust and other prerecorded sounds and/or algorithms for producing, enhancing or manipulating such sounds.

It will be appreciated by those skilled in the art having the benefit of this disclosure that these methods and apparatus for a vehicle audio system for producing synthetic sound provide significant advantages in comparison to earlier methods and apparatus. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

1. An electrically powered passenger vehicle comprising:
an electric drive motor operatively coupled to one or more of the vehicle's wheels for rotating the vehicle's wheels to propel the vehicle;
a battery pack for powering the electric drive motor;
a controller for controlling the speed of the vehicle;
a sensor for monitoring a performance parameter of the vehicle;
a data storage unit including one of pre-recorded engine sounds, pre-recorded exhaust sounds, or one or more algorithms for reproducing engine sounds and exhaust sounds;
a processor for accessing the data storage unit and retrieving one of pre-recorded engine sounds, pre-recorded exhaust sounds, or one or more algorithms for reproducing engine sounds and exhaust sounds;
an amplifier operably connected to the processor for amplifying one of an engine sound or exhaust sound;
at least one speaker operably connected the amplifier for projecting one of engine sounds or exhaust sounds outside the vehicle; and
wherein the processor receives an input generated by the sensor and varies a sound parameter of one of engine sounds or exhaust sounds projected by the speaker based on a performance parameter of the vehicle.

2. The electrically powered passenger vehicle of claim 1 wherein the performance parameters include one or more of the speed of the vehicle, acceleration of the vehicle, deceleration of the vehicle, speed of the drive motor and electric current draw of the drive motor.

3. The electrically powered passenger vehicle of claim 1 wherein the sound parameters include volume and frequency.

4. The electrically powered passenger vehicle of claim 1 further comprising at least one speaker oriented toward a front end of the vehicle and at least one speaker oriented toward the rear end of the vehicle wherein the speaker oriented toward the front of the vehicle is configured to project engine sounds outwardly from the vehicle and the speaker oriented toward the rear of the vehicle is configured to project exhaust sounds outwardly from the vehicle.

5. The electrically powered passenger vehicle of claim 1 further comprising a cellular transceiver connected to the processor whereby the processor can communicate with a third party service provider to download one of pre-recorded engine sounds, pre-recorded exhaust sounds, or one or more algorithms for reproducing engine sounds and exhaust sounds.

6. A method of providing prerecorded vehicle operating sounds or algorithms for reproducing vehicle operating sounds comprising:
receiving an electronic transmission from a user device operated by a potential purchaser with a server connected to a public or private computer network;
electronically transmitting selection information to the user device with the server connected to a public or private network, the selection information identifying vehicle sound selections including engine or exhaust sounds;
receiving an electronic transmission from the user device operated by the potential purchaser selecting one or more engine or exhaust sounds;
electronically transmitting one of a segment of a prerecorded engine or exhaust sound or an algorithm for producing an engine or exhaust sound to the user device via the public or private network;
receiving an electronic transmission from the user device confirming that the potential purchaser wishes to purchase one of a selected prerecorded engine or exhaust sounds or an algorithm for producing a selected engine or exhaust sound; and
electronically transmitting one of the selected prerecorded engine or exhaust sounds or an algorithm for producing a selected engine or exhaust sound to the user device.

7. The method of claim 6 further comprising electronically transmitting a prompt to the user device enabling the potential purchaser to select a payment type.

8. The method of claim 7 further comprising receiving an electronic transmission from the user device indicating a selected payment type.

9. The method of claim 8 further comprising electronically transmitting a request to a third party to confirm payment information received from the potential purchaser.

10. The method of claim 6, wherein the user device is a cellular transceiver.

11. The method of claim 6, wherein the selection information comprises a screen display.

12. The method of claim 6 further comprising electronically transmitting screen display information to the potential purchaser with the server connected to a public or private network, the display information including sound selections including one or more of engine sounds, exhaust sounds, wind sounds, road sounds and animal deterrent sounds for display on the user device.

13. An audio system for an electrically powered vehicle, the electrically powered vehicle having one or more vehicle performance sensors for sensing a vehicle performance parameter, the audio system comprising:
a data storage unit including one of pre-recorded engine sounds, pre-recorded exhaust sounds, or one or more algorithms for reproducing engine sounds and exhaust sounds;
a processor for accessing the data storage unit and retrieving one of pre-recorded engine sounds, pre-recorded exhaust sounds, or one or more algorithms for reproducing engine sounds and exhaust sounds;
an amplifier operably connected to the processor for amplifying one of an engine sound or exhaust sound;
at least one outwardly directed speaker mounted outside of the passenger compartment of the vehicle and operably connected to the amplifier for generating one of an engine or exhaust sound;
an interface between the processor and the one or more vehicle performance sensors for sensing a vehicle performance parameter, the interface configured to receive an input from the one or more vehicle performance sensors and transmit it to the processor; and
wherein the processor receives the input from at least one vehicle performance sensor and varies a sound parameter of one of engine sounds or exhaust sounds projected by the speaker based on a performance parameter of the vehicle.

14. The audio system of claim 13 wherein the vehicle performance parameters include one or more of the speed of the vehicle, acceleration of the vehicle, deceleration of the vehicle, speed of the drive motor and electric current draw of the drive motor.

15. The audio system of claim 13 wherein the sound parameters include volume and frequency.

16. The audio system of claim 13 further comprising at least one speaker oriented toward a front end of the vehicle and at least one speaker oriented toward the rear end of the vehicle wherein the speaker oriented toward the front of the vehicle is configured to project engine sounds outwardly from the vehicle and the speaker oriented toward the rear of the vehicle is configured to project exhaust sounds outwardly from the vehicle.

17. The audio system of claim 13 further comprising a cellular transceiver connected to the processor whereby the processor can communicate with a third party service provider to download one of pre-recorded engine sounds, pre-recorded exhaust sounds, or one or more algorithms for reproducing engine sounds and exhaust sounds.

18. A method of producing vehicle sounds associated with a combustion engine, comprising:
receiving an electronic transmission from a third party service provider, the electronic transmission including selection information for at least one of pre-recorded engine sounds, pre-recorded exhaust sounds, or one or more algorithms for reproducing engine sounds and exhaust sounds;
electronically transmitting a selection from at least one of pre-recorded engine sounds, pre-recorded exhaust sounds, or one or more algorithms for reproducing engine sounds and exhaust sounds;
electronically transmitting payment information to the third party service provider;
electronically receiving the one or more of pre-recorded engine sounds, pre-recorded exhaust sounds, or one or more algorithms for reproducing engine sounds and exhaust sounds;
storing the transmitted one or more of pre-recorded engine sounds, pre-recorded exhaust sounds, or one or more algorithms for reproducing engine sounds and exhaust sounds;
accessing the stored one or more of pre-recorded engine sounds, pre-recorded exhaust sounds, or one or more algorithms for reproducing engine sounds and exhaust sounds using an audio system of an electrically powered passenger vehicle to reproduce one or more of an engine sound or exhaust sound; and
producing an engine or exhaust sound with the audio system of an electrically powered passenger vehicle wherein the audio system receives an input generated by at least one vehicle performance parameter sensor and varies a sound parameter of one of engine sounds or exhaust sounds produced by the audio system based on the performance parameter of the vehicle.

19. The method of claim 18 wherein the performance parameters include one or more of the speed of the vehicle, acceleration of the vehicle, deceleration of the vehicle, speed of the drive motor and electric current draw of the drive motor.

20. The method of claim 18 wherein the sound parameters include volume and frequency.
